(19) United States
(12) Patent Application Publication
(10) Pub. No.: US 2004/0040994 A1
(43) Pub. Date: Mar. 4, 2004

(54) Hands free article support for supporting various articles in a vehicle and articles supported thereby

(76) Inventor: Justin Troy Parcelles, Rockville, MD (US)

Correspondence Address: MEREK & VOORHEES, 673 South Washington Street, Alexandria, VA, 22314, US

(21) Appl. No.: 10/227,837

(22) Filed: Aug. 27, 2002

(51) Int. Cl. B60R 7/06

(52) U.S. Cl. 224/483

(57) ABSTRACT

A hands free article support for supporting various articles in a vehicle and articles supported thereby. Preferably, the article support includes a body having an opening for receiving a predetermined portion of a vent of a vehicle. The body has an upper portion, a lower portion, a rear portion and a front portion. An attachment member extends forwardly from the front portion. The article support preferably includes a release member for permitting the body to be removed from the predetermined portion of the vent of a vehicle. Preferably, the article or articles supported by the hands free article support include a removable portion permitting the article to be readily and easily hung from the hands free article support. The removable portion may but need not include indicia corresponding to a game being played by a fast food provider with its customers. In its most preferred form, the article supported by the hands free article support is a french fry container or package.

### FIELD OF THE INVENTION

The present invention is directed to an article support for supporting various articles in a vehicle. Further, the present invention is directed to articles supported by an article support deployed in a vehicle. In its most preferred form, the present invention is directed to a hands free support for supporting a fast food product container or package (e.g. a french fry container or package) in an automobile allowing occupants of the vehicle to access the fast food product without supporting the container or package with their hands or any other portion of their body. In addition, another most preferred form of the present invention is directed to a french fry container or package adapted to be hung from an article support deployed in an automobile.

### BACKGROUND OF THE INVENTION

Inhabitants of industrial nations including citizens of the United States and many other nations are accustomed to the convenience and availability of automobiles. Occupants of automobiles including but not limited to the driver of the vehicle access various items while in the automobile. These items include fast food products, among other items. Numerous different fast food suppliers cater to the inhabitants of industrial nations. In fact, a number of different fast food suppliers have “drive-thru” windows allowing individuals to conveniently purchase various different fast food products without ever leaving their car. Fast food products are commonly provided to the consumer in variety of different packages or containers.

As a result of mobile societies, it has become commonplace for the occupants of automobiles to perform various daily tasks including eating while driving. This fact of mobile societies has led to the development of many different kinds of drink and food holders for use in automobiles. One example is specially designed trays developed to hold various fast food products. These trays may be supported in the lap of the occupant of the vehicle such as the tray disclosed in U.S. Pat. No. 5,069,375. The tray disclosed in U.S. Pat. No. 5,069,375 is provided with a specially designed clip to secure the tray to the seat belt of a vehicle. The tray disclosed in U.S. Pat. No. 5,114,108 is a molded plastic tray having integrally molded compartments depending from a generally flat surface. The compartments are configured to receive various fast food products. The tray is provided with a supporting hook in order to mount the tray on a vehicle door.

Other devices developed to accommodate fast food products include food consoles such as disclosed in U.S. Pat. No. D456,761. Some devices such as those disclosed in U.S. Pat. Nos. 5,667,119 and D454,035 have been designed to handle a specific type of fast food, i.e., french fries.

Previously developed devices for supporting items (e.g., fast food products) accessed by individuals while driving suffer from numerous inherent disadvantages. For example, the tray type support devices are inordinately large thereby increasing the cost of manufacture of the device. Further, these large trays are unsightly and unnecessarily reduce the usable space in the passenger compartment of a vehicle. Moreover, trays are difficult to store when not in use. Additionally, trays situated on an individuals lap unduly restrict movement of the individual.

Console type support devices are also inordinately large and unsightly. In addition, console type devices require a particularly configured passenger compartment having a suitable area for accommodating the console. Not all passenger compartments can readily accommodate console type devices. This is particularly true in small automobiles.

Devices mounted to various portions of an automobile door are undesirable for various reasons. First, the door cannot be readily opened and/or closed without risking spillage of the fast food product. Alternatively, the device must be removed before the door is opened or closed. Further, where the device is mounted to the window, the device must be removed before the window can be opened.

Previously known devices to support various items in an automobile are further undesirable because they cannot be readily and easily stored in the passenger compartment when not in use without taking up an inordinate amount of valuable storage space in the passenger compartment.

Accordingly, a significant need exists for a product that overcomes the numerous inherent disadvantageous of the prior art.

### OBJECTS AND SUMMARY OF THE INVENTION

An object of a preferred embodiment of the present invention is to provide a novel and unobvious hands free article support for use in an automobile.

Another object of a preferred embodiment of the present invention is to provide a novel and unobvious container or package for use with a hands free article support.

A further object of a preferred embodiment of the present invention is to provide a hands free article support that can be used in a variety of different size and styles of automobiles.

Still a further object of a preferred embodiment of the present invention is to provide a hands free article support that can be readily and easily stored when not in use.

Yet still another object of a preferred embodiment of the present invention is to provide a hands free article support that takes up only an extremely small space in a passenger compartment when being used.

Yet still a further object of a preferred embodiment of the present invention is to provide a hands free article support that can be inexpensively manufactured.

Another object of a preferred embodiment of the present invention is to provide a hands free article support that can be disposed of after use.

Still another object of a preferred embodiment of the present invention is to provide a hands free article support that does not restrict the ability of occupants of a vehicle to open and close automobile doors.

Yet still another object of a preferred embodiment of the present invention is to provide a hands free article support that does not restrict the ability of occupants of a vehicle to open and close automobile windows.

Yet a further object of a preferred embodiment of the present invention is to provide a hands free article support that does not restrict the mobility of occupants of a vehicle.

Another object of the present invention is to provide a container that can be readily mounted on a hands free article support deployed in an automobile.

Yet another object of the present invention is to provide a container for use with a hands free article support that includes indicia corresponding to a game the fast food provider plays with its consumer.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one embodiment of the present invention is directed to an article support for supporting an article in a motorized vehicle allowing occupants of the vehicle to access the article without supporting the article with the occupants hands or any other portion of the occupants body. The article support includes a body having an opening for receiving a predetermined portion of a vent of a vehicle. The body has an upper portion, a lower portion, a rear portion and a front portion. An attachment member extends forwardly from the front portion. The article support includes a release member for permitting the body to be removed from the predetermined portion of the vent of a vehicle.

Another embodiment of the present invention is directed to an apparatus having an article support. The article support includes a body having an opening for receiving a predetermined portion of a vent of a vehicle. The body has an upper portion, a lower portion, a rear portion and a front portion. The article support further includes an attachment member extending forwardly from the front portion. The apparatus further includes an article supported by the article support. The article has a front surface, a rear surface, a left side surface, a right side surface and a bottom surface. The article further has an opening formed in one of the front, rear, left side, right side and bottom surfaces. The attachment member is inserted into the opening of the article whereby the article hangs from the article support.

A further embodiment of the present invention is directed to an apparatus for holding a fast food product. The apparatus includes a french fry package for holding french fries. The french fry package has a front surface, a top, a rear surface, a left side surface, a right side surface and a bottom surface. The top is open thereby permitting french fries to be placed into the french fry package. One of the front, rear, left side, right side and bottom surfaces of the french fry package has an opening formed therein. The opening has a sufficient size to receive a portion of a support member whereby the french fry package can be readily supported in a hands free manner by the support member.

Still another embodiment of the present invention is directed to an apparatus for holding a fast food product. The apparatus includes a french fry package for holding french fries. The french fry package has a front surface, a top, a rear surface, a left side surface, a right side surface and a bottom surface. The top is open thereby permitting french fries to be placed into the french fry package. One of the front, rear, left side, right side and bottom surfaces of the french fry package has a removable section that forms an opening when removed. The opening formed upon removal of the removable section has a sufficient size to receive a portion of a support member whereby the french fry package can be readily supported in a hands free manner by the support member. The removable section has indicia for a game in which prizes are awarded by a fast food provider.

Yet still another embodiment of the present invention is directed to an apparatus including a vent of a motorized vehicle, an article support and a french fry package supported by the article support. The vent has a plurality of air distributors. The article support includes a body having at least one opening for receiving one of the plurality of air distributors. The body further has an upper portion, a lower portion, a rear portion and a front portion. The article support further includes an attachment member extending forwardly from the front portion of the body. The french fry package is supported by the article support adjacent the attachment member.

### BRIEF DESCRIPTION OF THE DRAWINGS

FIG. 1 is a side view of an article support formed in accordance with the most preferred embodiment of the present invention.

FIG. 2 is a bottom view of the article support depicted in FIG. 1.

FIG. 3 is a side view of an initial step in the most preferred method of attaching the article support to the vent of an automobile.

FIG. 4 is a side view of a subsequent step in the most preferred method of attaching the article support to the vent of an automobile.

FIG. 5 is a side view of another subsequent step in the most preferred method of attaching the article support to the vent of an automobile.

FIG. 6 is a side view of a further subsequent step in the most preferred method of attaching the article support to the vent of an automobile.

FIG. 7 is a fragmentary perspective view of one of many possible items supported by the article support depicted in FIG. 1.

FIG. 8 is a perspective view of the article support depicted in FIG. 1.

FIG. 9 is a perspective view of the most preferred form of an article supported by the article support depicted in FIG. 1.

FIG. 10 is a side view of an alternative form of the article support.

FIG. 11 is a bottom view of the article support depicted in FIG. 10.

### DETAILED DESCRIPTION OF THE PREFERRED EMBODIMENT OF THE INVENTION

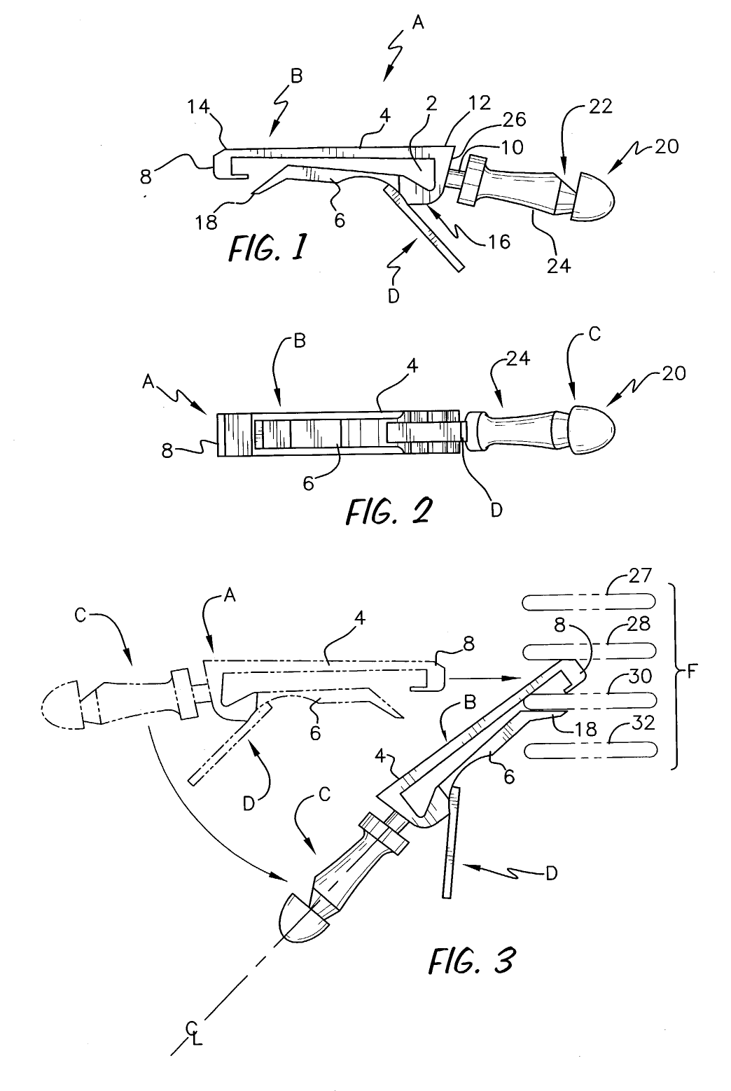

The most preferred forms of the invention will now be described with reference to FIGS. 1-9. The appended claims are not limited to the most preferred embodiments and no term used herein is to be given a meaning other than its ordinary meaning unless accompanied by a statement that the term “as used herein is defined as follows”.

### FIGS. 1 through 9

Referring to FIG. 1, a hands free article support A is illustrated in one of many possible configurations. The hands free article support A may be made of any suitable material including but not limited to metal, plastic or rubber. The hands free article support A includes a body B, an attachment member C and a release member D. The body B includes an opening 2 for receiving a predetermined portion of a vent of a vehicle as explained in greater detail below. The body B further includes an upper portion 4, a lower portion 6, a rear portion 8 and a front portion 10. The upper portion 4 has first end 12 and second end 14. Similarly, the lower portion 6 has first end 16 and second end 18. The first end 12 of the upper portion 4 is connected to the first end 16 by the front portion 10. The second end 18 of lower portion 6 is spaced from the rear portion 8 thereby defining a passageway through which a predetermined portion of the vent of a vehicle passes when the article is mounted for use. Preferably, the rear portion 8 is substantially U-shaped.

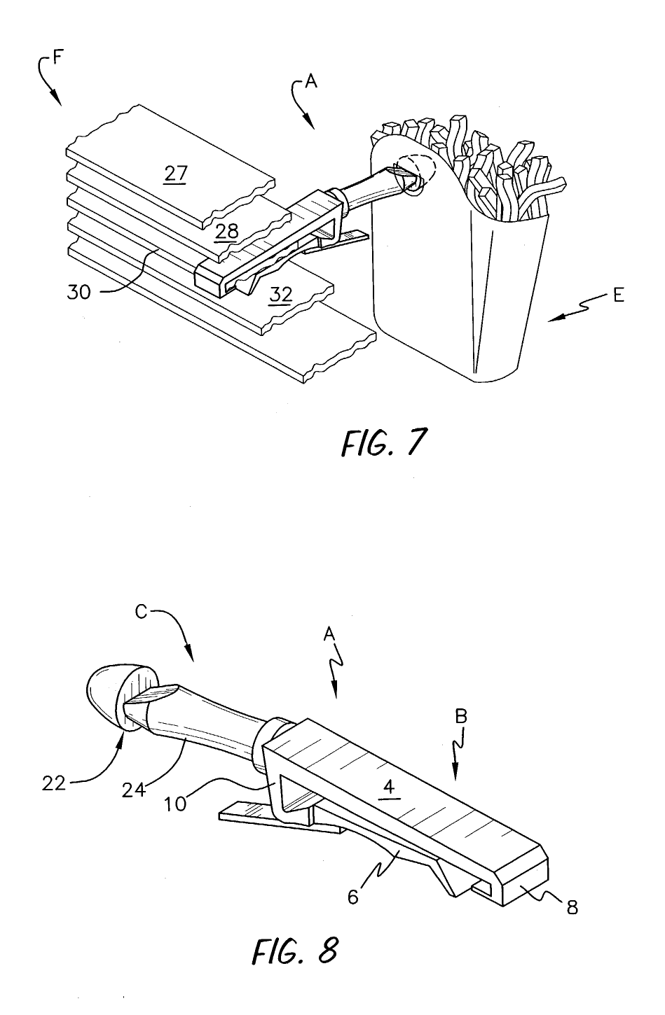

The attachment member C extends forwardly from the front portion 10 a sufficient distance to space the article from the air distributor. Preferably, the attachment member C is substantially symmetrical as seen in FIGS. 1, 2 and 9. The attachment member includes a curved head 20, a first reduced section 22, a body section 24 and a second reduced section 24. As seen in FIG. 7, the article E supported by the hands free article support A is preferably hung from the first reduced section 22. The release member D is preferably connected to the lower portion 6 of body B. It must be understood that while the preferred forms of the body B, attachment member C and release member D are depicted in FIGS. 1 through 9, it will be readily appreciated that the configuration and orientation of these components may be varied. Further, various ones of theses components may be omitted in their entirety to accommodate any given circumstance.

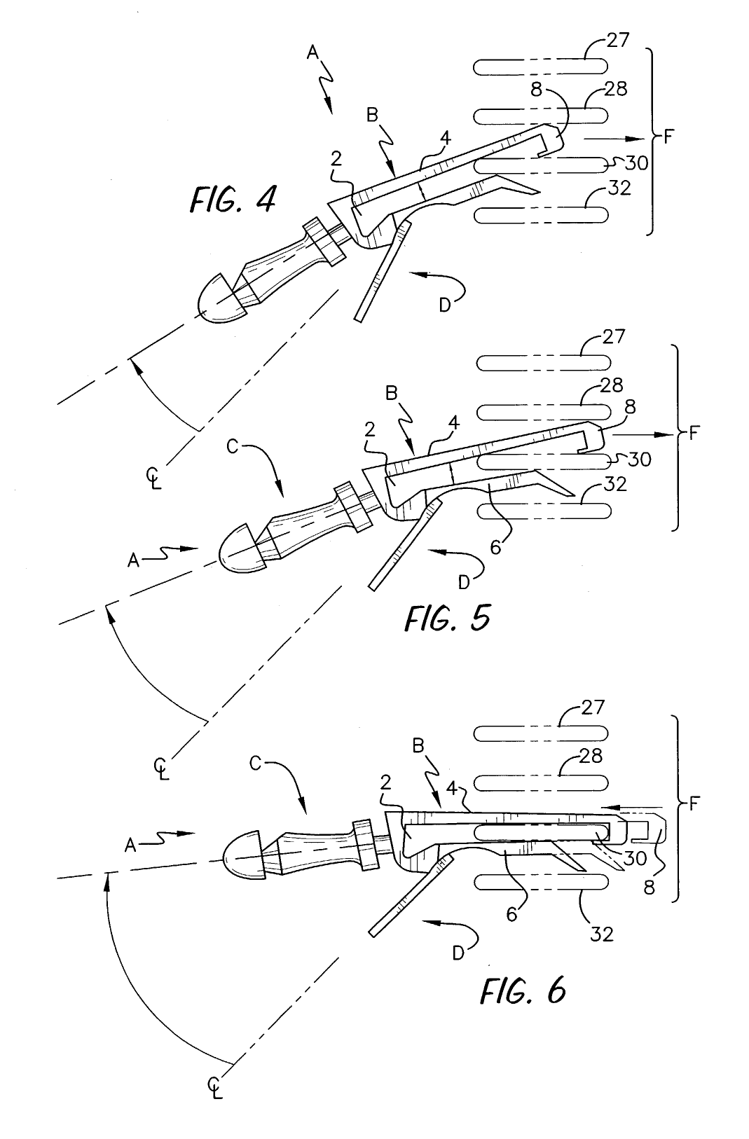

FIGS. 3 through 6 depict one of many methods of attaching the hands free article support to a vent F of an automobile. The vent F is depicted as having four horizontally oriented air distributors 26, 28, 30 and 32. It will be readily appreciated that the number and orientation of air distributors may be varied. For example, and without limitation, the vent could include a plurality of horizontally oriented air distributors and a plurality of vertically oriented air distributors. Further, the air distributors could be fixed or adjustable. As depicted in FIG. 3, the hands free article support A is oriented relative to an air distributor such that the passageway or space formed between the lower portion 6 and the rear portion 8 is aligned with the air distributor. As seen in FIGS. 4 and 5, the article support A is rotated upwardly and inserted further into the vent. As seen in FIG. 6, the article support A is then manipulated such that the substantially U-shaped rear portion 8 engages the back of the air distributor. In the installed position depicted in FIG. 6, the air distributor 30 is positioned in the opening 2 of body B. It will be readily appreciated that the hands free article support A could be mounted on any of the air distributors. To remove the hands free article support A, the release member is pushed upwardly toward the attachment member C causing the lower portion 6 to rotate downwardly away from the air distributor 30. At approximately the same time, the hands free article support A is pushed into the vent slightly to dislodge the substantially U-shaped rear portion 8 from the back of the air distributor 30.

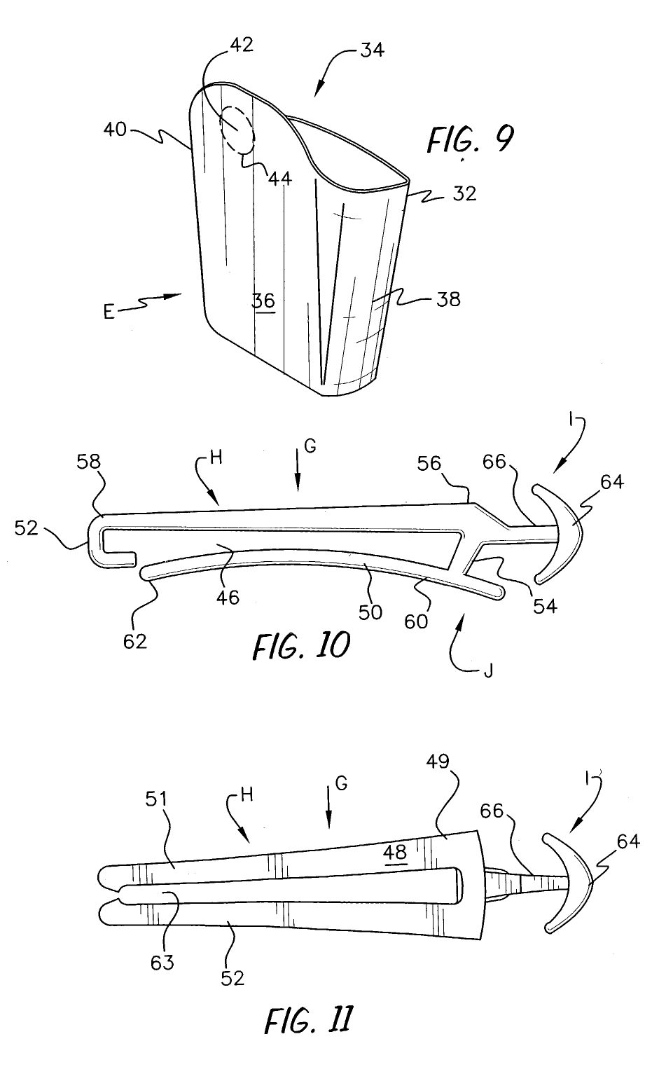

In its preferred form the article supported by the hands free article support A is a french fry container E, as seen in FIGS. 7 and 9. However, it will be readily appreciated that many other items may be supported by the article support A including but not limited to fast food items other than french fries or non-food products such as note pads, telephones, signs, etc. The french fry container includes a front surface 32, a top 34, a rear surface 36, a left side surface 38 and a right side surface 40. Preferably, the rear surface 36 includes a removable section 42. The outer perimeter of the removable section 42 is defined by one or more weakness lines 44. While the removable section 42 is depicted as having a circular shape, it can be configured in any manner desired. Further, the removable section 42 may be provided with indicia corresponding to a game the fast food provider plays with its customers. The indicia cold be initially hidden and require the customer to scratch off a cover surface. Alternatively, the indicia could be readily visible. Once the removable section 42 is separated from the remaining portion of the rear surface 36, an opening is formed of sufficient size to receive the head 20 of attachment member C. In this manner, the container E is readily hung from the hands free article support A. It should be noted that the head 20 could be configured in any manner and could take the form of a popular cartoon character or other recognizable symbol.

Referring to FIGS. 10 and 11, one of many possible alternative forms of the hands free article support is depicted. The hands free article support G includes a body H, an attachment member I and a release member J. The body H includes an opening 46 for receiving a predetermined portion of a vent of a vehicle as explained in greater detail below. The body H further includes an upper portion 48, a lower portion 50, a rear portion 52 and a front portion 54. The upper portion 48 has first end 56 and second end 58. Similarly, the lower portion 50 has first end 60 and second end 62. The first end 56 of the upper portion 48 is connected to the first end 60 by the front portion 54. The second end 62 of lower portion 50 is spaced from the rear portion 52 thereby defining a passageway through which a predetermined portion of the vent of a vehicle may pass when the article is mounted for use. Upper portion 48, as seen in FIG. 11, includes an opening 63. The area 49 of upper portion 48 is enlarged to allow an individual to squeeze that area with two fingers resulting in the legs 51 and 53 spreading apart to facilitate removal. Lower portion 50 also includes an opening similar to opening 63. Although not shown lower portion 50 has an area similar to area 49 for the same purpose. The openings of the upper and lower portions of the body H can receive a vertically oriented air distributor so that the hands free article support G is mounted on the vertically oriented air distributor. Preferably, the rear portion 52 is substantially U-shaped. It will be readily appreciated that the rear portion 52 can be configured in any manner desired.

Referring to FIG. 10, the attachment member I extends forwardly from the front portion 54. The attachment member includes a curved head 64 and a first reduced section 66. The article supported by the hands free article support G is preferably hung from the first reduced section 66. The release member J is preferably connected to the lower portion 50 of body H. It must be understood that while one of the preferred forms of the body H, attachment member I and release member J are depicted in FIGS. 10 and 11, it will be readily appreciated that the configuration and orientation of these components may be varied. Further, various ones of theses components may be omitted in their entirety to accommodate any given circumstance. The hands free article support G is mounted in a similar manner

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

I claim:

1. An article support for supporting an article in a motorized vehicle allowing occupants of the vehicle to access the article without supporting the article with the occupants hands or any other portion of the occupants body, said article support comprising:
(a) a body having an opening for receiving a predetermined portion of a vent of a vehicle, said body having an upper portion, a lower portion, a rear portion and a front portion;
(b) an attachment member extending forwardly from the front portion; and,
(c) a release member for permitting said body to be removed from the predetermined portion of the vent of a vehicle.

2. An article support, as recited in claim 1, wherein:
(a) said body, said attachment member and said release member are formed from plastic.

3. An article support, as recited in claim 1, wherein:
(a) said upper and lower portions each have first and second ends, said first end of said upper portion and said first end of said lower portion are connected to said front portion.

4. An article support, as recited in claim 3, wherein:
(a) said rear portion is substantially U-shaped.

5. An article support, as recited in claim 4, wherein:
(a) said second end of said lower portion is spaced from said rear portion thereby defining a space through which the predetermined portion of the vent of a vehicle passes when the article support is mounted.

6. An article support, as recited in claim 5, wherein:
(a) the release member is connected to said lower portion of said base.

7. An apparatus, comprising:
(a) an article support including a body having an opening for receiving a predetermined portion of a vent of a vehicle, said body having an upper portion, a lower portion, a rear portion and a front portion, said article support further including an attachment member extending forwardly from said front portion, said article support further including a release member for permitting said body to be removed from the predetermined portion of the vent of a vehicle;
(b) an article supported by said article support, said article having a front surface, a rear surface, a left side surface, a right side surface and a bottom surface, said article further having an opening formed in one of said front, rear, left side, right side and bottom surfaces; and,
(c) said attachment member being inserted into said opening of said article whereby said article hangs from said article support.

8. An apparatus, as recited in claim 7, further including:
(a) a release member for permitting said body to be removed from the predetermined portion of the vent of a vehicle.

9. An apparatus, as recited in claim 8, wherein:
(a) said release member is connected to said lower portion of said body.

10. An apparatus, as recited in claim 7, wherein:
(a) said body, said attachment member and said release member are formed from plastic.

11. An apparatus, as recited in claim 7, wherein:
(a) said upper and lower portions each have first and second ends, said first end of said upper portion and said first end of said lower portion are connected to said front portion.

12. An apparatus, as recited in claim 11, wherein:
(a) said rear portion is substantially U-shaped.

13. An apparatus, as recited in claim 12, wherein:
(a) said second end of said lower portion is spaced from said rear portion thereby defining a space through which the predetermined portion of the vent of a vehicle passes when the article support is mounted.

14. An apparatus for holding a fast food product, said apparatus comprising:
(a) a french fry package for holding french fries, said french fry package including a front surface, a top, a rear surface, a left side surface, a right side surface and a bottom surface, said top being open thereby permitting french fries to be placed into said french fry package; and,
(b) one of said front, rear, left side, right side and bottom surfaces of said french fry package having an opening formed therein, said opening having a sufficient size to receive a portion of a support member whereby said french fry package can be readily supported in a hands free manner by the support member.

15. An apparatus for holding a fast food product, said apparatus comprising:
(a) a french fry package for holding french fries, said french fry package including a front surface, a top, a rear surface, a left side surface, a right side surface and a bottom surface, said top being open thereby permitting french fries to be placed into said french fry package; and,
(b) one of said front, rear, left side, right side and bottom surfaces of said french fry package having a removable section that forms an opening when removed, said opening formed upon removal of said removable section having a sufficient size to receive a portion of a support member whereby said french fry package can be readily supported in a hands free manner by the support member; and,
(c) said removable section having indicia for a game in which prizes are awarded by a fast food provider.

16. An apparatus, as recited in claim 15, wherein:
(a) said removable section is substantially circular.

17. An apparatus, comprising:
(a) a vent of a motorized vehicle, said vent having a plurality of air distributors;
(b) an article support including a body having at least one opening for receiving one of said plurality of air distributors, said body further having an upper portion, a lower portion, a rear portion and a front portion, said article support further including an attachment member extending forwardly from said front portion of said body;
(c) a french fry package supported by said article support adjacent said attachment member.

18. An apparatus, as recited in claim 17, wherein:
(a) said plurality of air distributors are oriented horizontally.

19. An apparatus, as recited in claim 17, wherein:
(a) a first elongated opening is formed in said upper portion of said body for receiving one of said plurality of air distributors.

20. An apparatus, as recited in claim 19, wherein:
(a) a second elongated opening is formed in said lower portion of said body for receiving one of said plurality of air distributors.
